(19) United States
(12) Patent Application Publication
(10) Pub. No.: US 2010/0218571 A1
(43) Pub. Date: Sep. 2, 2010

(54) COMBINATION LOCK ASSEMBLIES AND METHODS FOR MARKING COMBINATION LOCK ASSEMBLIES INCLUDING DISTRIBUTIONS OF CONSONANTS AND VOWELS

(76) Inventor: Todd Basche, Los Altos, CA (US)

Correspondence Address: PERKINS COIE LLP;PATENT-SEA, P.O. BOX 1247, SEATTLE, WA, 98111-1247, US

(21) Appl. No.: 12/716,240

(22) Filed: Mar. 2, 2010

Related U.S. Application Data
(60) Provisional application No. 61/156,823, filed on Mar. 2, 2009.

(51) Int. Cl. E05B 37/04

(52) U.S. Cl. 70/302; 29/592

(57) ABSTRACT

The present disclosure describes tumbler-style combination locks and methods for marking tumbler-style combination locks. The locks include a locking member movable between locked and unlocked configurations with respect to a lock body and a plurality of tumblers individually rotatable with respect to the body. A textual unlocking combination for moving the locking member to the unlocked configuration includes a word spelled by an alignment of letters on the plurality of tumblers. A plurality of letter strings is equal in number to the plurality of tumblers and individual tumblers include an individual letter string that has an individual distribution of consonants and vowels.

### CROSS-REFERENCE TO RELATED APPLICATIONS

This application claims priority to and the benefit of U.S. Provisional Application No. 61/156,823, filed Mar. 2, 2009 and titled TUMBLER-STYLE COMBINATION LOCK ASSEMBLIES AND ALGORITHMS FOR MARKING TUMBLER-STYLE COMBINATION LOCK ASSEMBLIES INCLUDING DISTRIBUTIONS OF CONSONANTS AND VOWELS, which is incorporated herein by reference in its entirety.

### TECHNICAL FIELD

The present disclosure relates to combination locks in which the combination can be freely set or changed to another combination by the user. In particular, the present disclosure relates to combination locks that use letters to spell a word as an unlocking combination of the lock.

### BACKGROUND

Locks are commonly used for securing a wide variety of objects. For instance, locks are frequently used to secure lockers, toolboxes, luggage, bags, gates, doors, containers, bicycles, vehicles and the like. One main disadvantage of a key-based lock is that a physical key is required to open the lock. Another disadvantage of a key-based lock is that a user typically cannot reset or change the key configuration without also replacing the lock.

Combination locks overcome many of the disadvantages of key-based locks by providing a numeric combination instead of a physical key to open the lock. Two common types of numeric based combination locks are rotary-style and tumbler-style locks. Rotary-style locks generally have a rotating dial that displays a range of numbers; whereas conventional tumbler-style locks generally have three to five tumblers or wheels that each display the numbers 0-9. These numeric based combination locks, however, also have many disadvantages. For example, the numeric combination to open the lock is often preset by the manufacturer of the lock. Accordingly, a user is forced to learn an unrelated or random numeric sequence that may be difficult to remember. In addition, even if a user may reset or customize the numeric combination, many users simply have trouble remembering numeric combinations. With a numeric combination lock, if the user forgets the numeric combination the user must typically destroy the lock to open and remove the lock, which can be inconvenient and expensive. Further, as noted above, tumbler-style combination locks typically only display ten numbers (e.g., 0-9) per tumbler, thereby limiting the possible combinations that are available.

Textual combination locks have been developed that allow for a variety of displayed word combinations that are easier for the user to remember. According to one conventional tumbler-style combination lock, letter strings on the tumblers are selected to spell a collection of words. The letter strings on the tumblers can be selected to maximize the number of words in the collection that can be spelled.

The letter strings on the tumblers can be selected based on a frequency analysis. In particular, a word collection is analyzed to determine the frequency that each letter occurs. The most frequently occurring letters are selected for the letter string on the tumbler that corresponds to the letter position in the word collection. For example, a collection of three letter words would be analyzed and the ten letters that occur most frequently as the beginning letter of the words in the collection would be selected for the letter string on the first tumbler. Similarly, the ten letters that occur most frequently as the middle and last letters would be selected for the letter strings on the second and third tumblers, respectively.

A tumbler-style textual combination lock also can use a word collection that includes specifically selected related words. It is sometimes the case that a user may find it easier to remember an unlocking combination that is selected in relation to the application of the lock. For example, a word collection for a lock that is intended to appeal to bicyclists can specifically include words such as “RIDE” or “BIKE.” Alternatively, a word collection can be specifically selected based on an association with a product, an activity, or a marketing promotion. For example, a word collection for a lock that is to be associated with a marketing promotion by a fitness center can include words such as “LIFT” or “WALK.”

Word collections that include specifically selected related words may, however, reduce the number of possible words that can be spelled. In particular, the letter string for one or more of the tumblers will likely need to be adjusted to include a particular letter(s) necessary to spell the specifically selected words. This can skew a frequency analysis from that of a broader word collection. These are some of the factors and can make it easier for an unauthorized person to deduce the word used as the unlocking combination for the lock.

### SUMMARY

Embodiments in accordance with the present disclosure include a tumbler-style combination lock bearing alphabetic letters or symbolic characters on a plurality of tumblers.

Embodiments in accordance with the present disclosure include a textual combination lock bearing alphabetic letters or symbolic characters that spell a word to open the combination lock.

Embodiments in accordance with the present disclosure include a textual combination lock including individual tumblers bearing strings of letters that have a preset distribution of consonants and vowels.

Embodiments in accordance with the present disclosure include a textual combination lock including individual tumblers bearing strings of letters that have a preset distribution of consonants and vowels, with the consonants and vowels of each letter string being either selected randomly and/or preselected.

Embodiments in accordance with the present disclosure include a textual combination lock include individual tumblers bearing strings of letters that have a preset distribution of non-duplicative consonants and vowels.

Embodiments in accordance with the present disclosure include a method for marking a textual combination lock including determining distributions of consonants and vowels for individual tumblers.

Embodiments in accordance with the present disclosure include a method for marking a textual combination lock including selecting strings of letters in accordance with the distributions for individual tumblers, with the letters in the individual strings being selected either randomly or based on a frequency analysis.

Embodiments in accordance with the present disclosure include a method for marking a textual combination lock that includes excluding individual objectionable words as possible unlocking combinations.

Embodiments in accordance with the present disclosure include a method for marking a textual combination lock that includes using a threshold value to ensure a minimum amount of words is spelled.

### BRIEF DESCRIPTION OF THE DRAWINGS

FIG. 1 is a perspective view showing a locked configuration of a combination locking device in accordance with an embodiment of the present disclosure.

FIG. 2A is a perspective view showing an unlocked configuration of the combination locking device shown in FIG. 1.

FIG. 2B is a left side detail view illustrating a process step for changing an unlocking combination of the combination locking device shown in FIG. 2A.

FIG. 3 is a perspective view illustrating another process step for changing an unlocking combination of the combination locking device shown in FIG. 1.

FIG. 4A is a perspective view illustrating another process step for changing an unlocking combination of the combination locking device shown in FIG. 1.

FIG. 4B is a left side detail view illustrating another process step for changing an unlocking combination of the combination locking device shown in FIG. 4A.

FIG. 5 is a chart illustrating an example of character strings for a combination locking device in accordance with an embodiment of the present disclosure.

### DETAILED DESCRIPTION

The following describes embodiments of textual combination locks and methods of manufacturing the locks in accordance with the present disclosure. Embodiments of textual combination locks can include word-based combination locks such as, but are not limited to padlocks, luggage locks, bike locks, and cable locks. Embodiments in accordance with the present disclosure are set forth hereinafter to provide a thorough understanding and enabling description of a number of particular embodiments. Numerous specific details of various embodiments are described below with reference to textual combination locks having alphabetical letters or symbolic characters, but embodiments can be used with other locks and with other indicia. In some instances, well-known structures or operations are not shown, or are not described in detail to avoid obscuring aspects of this invention. A person skilled in the art will understand, however, that the invention may have additional embodiments, or that the invention may be practiced without one or more of the specific details of the embodiments as shown and described.

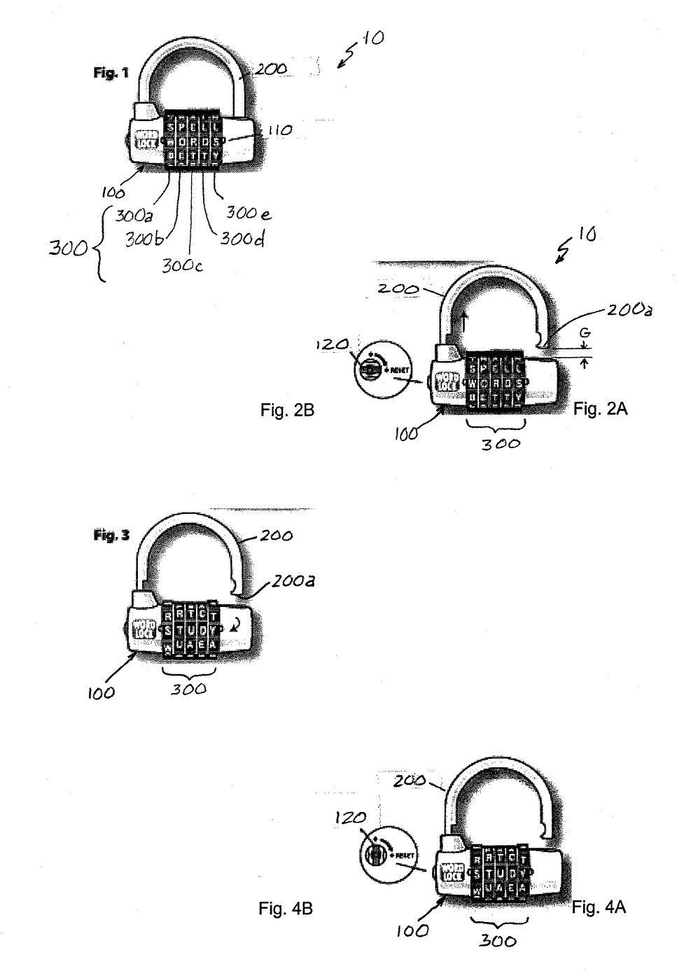

FIG. 1 shows a locked configuration of a textual tumbler-style combination locking device 10 in accordance with an embodiment of the present disclosure. The lock assembly 10 generally includes a body 100, a locking member 200, and a plurality of coaxially positioned tumblers 300 (five individual tumblers 300a-300e are illustrated). The locking member 200, which may be a hasp, a shackle, or another suitably strong member, is operatively coupled to the body 100 such that the locking member 200 can move between the locked configuration shown in FIG. 1 and an unlocked configuration (See FIGS. 2-4). In the embodiment shown in FIGS. 1-4, the movement between the locked and unlocked configurations includes displacing and pivoting the locking member 200 with respect to the body 100. The tumblers 300 are individually rotatable with respect to the body 100.

Other embodiments according to the present disclosure can use less than or more than five individual tumblers. The number of tumblers can affect the number of unlocking combinations that are available, the complexity of the locking mechanism, and/or the likelihood that an unauthorized person can deduce the unlocking combination. For example, reducing the number of tumblers decreases the absolute number of combinations that are possible, i.e., regardless of whether each combination spells a word. Similarly, increasing the number of tumblers can increase the number of letters in an unlocking combination word and therefore decrease the number of words that could possibly be spelled with the limited strings of letters that are available on each tumbler. Moreover, connecting additional tumblers to the locking mechanism can increase the complexity and therefore the cost of the lock.

According to other embodiments of the present disclosure, certain adverse effects of increasing the number of tumblers may be mitigated by (1) using a phrase for the unlocking combination and/or (2) using dummy tumblers. Selecting a phrase that, for example, includes two short words as opposed to one long word as the unlocking combination can increase the number of words that could possibly be spelled with the strings of letters that are available on each tumbler. A two-word phrase for the unlocking combination can be facilitated by including a blank in one or more of the strings for intermediate tumblers. Dummy tumblers or tumblers that are included in the plurality of tumblers but are not operatively coupled to the locking mechanism can also increase the number of words that could possibly be spelled with the strings of letters that are available on each tumbler. For example, including a blank in each of the strings for the individual tumblers can obfuscate which tumblers are used to spell the unlocking combination.

FIG. 2A shows the unlocked configuration of the device 10. A gap G is provided between the body 100 and a free end 200a of the locking member 200 in the unlocked configuration of the device 10. An object (not shown) that is to be secured by the device 10 can be moved relative to the device 10 so as to pass through the gap G.

To move to the locked configuration of the device 10, the locking member 200 can be moved, e.g., displaced, translated, pivoted, rotated, or a combination thereof, such that the free end 200a engages with the body 100. In other embodiments, the free end 200a is positioned in such proximity to the body 100 as to reduce or eliminate the gap G. Accordingly, in the locked configuration of the device shown in FIG. 1, the object (not shown) that is being secured cannot pass between the body 100 and the free end (not shown in FIG. 1) of the locking member 200. The body 100 may also include an indicator 110 (e.g., a notch, protrusion, arrowhead, line, etc.) positioned on the body 100. In several embodiments, the indicator 110 identifies to a user where to rotatably position the tumblers 300 with respect to the body 100 so as to transition at least from the locked configuration of the device 10 to the unlocked configuration of the device 10.

A process for setting a new unlocking combination will now be described with respect to FIGS. 1-4B. To begin, the character strings on the individual tumblers 300a-300e are reviewed to ascertain the characters available on each of the tumblers 300. The new unlocking combination can be any word that can be spelled starting with one of the letters on the tumbler 300a, and continuing with one of the letters on each of the tumblers 300b-300e, respectively.

The tumblers 300 are then rotated to spell the current unlocking combination, e.g., as provided by the manufacturer. Specifically, the tumblers 300a-300e are individually rotated to spell the current unlocking combination in alignment with the indicator 110 (e.g., “WORDS” in the embodiment shown in FIGS. 1 and 2A). The device 10 can now be opened by moving the locking member 200 to the unlocked configuration, e.g., to produce the gap G between the free end 200a and the body 100. Referring to FIG. 2B, a flat tool or a coin can be used to rotate a slot 120 to point to a “RESET” position on the body 100.

The tumblers 300 are then rotated to spell the new unlocking combination. Specifically, the tumblers 300a-300e are individually rotated to spell the new unlocking combination in alignment with the indicator 110. Referring to FIG. 4B, the slot 120 can be rotated back to its original position, thereby setting the new unlocking combination, and the locking member 200 can be moved to the locked configuration (See FIG. 1). Accordingly, the original locking combination has been reset with the new locking combination (e.g., “STUDY” in the embodiment shown in FIGS. 3 and 4A).

The words that are available to be used as an unlocking combination are defined by the strings of letters on the individual tumblers 300a-300e. According to embodiments of the present disclosure, a string of ten letters is randomly selected from an alphabet, e.g., A-Z, for each tumbler 300. In other embodiments, a string of letters on an individual tumbler can include more or less than ten letters, and can be selected from any suitable alphabet, e.g., Spanish, Greek, Cyrillic, Braille, etc. In some embodiments, the alphabet can be considered to additionally include a null or blank character as discussed above.

Embodiments in accordance with the present disclosure include individual distributions of consonants and vowels in the individual letter strings. A distribution as it is used in the present disclosure can be characterized by a ratio of the number of consonants to the number of vowels. For example, a string of ten letters having a distribution of nine consonants and one vowel has a consonant-to-vowel ratio of 9:1. The distributions for individual letter strings can be the same or different for a plurality of tumblers 300. Accordingly, more than one tumbler 300 can have the same consonant-to-vowel ratio or each of the tumblers 300 can have different consonant-to-vowel ratios.

The distribution for an individual letter string is determined prior to selecting the letters in the letter string. The numbers of consonants and vowels in an individual letter string is therefore known when selecting the consonants and vowels. For example, a distribution for a string of ten letters having a consonant-to-vowel ratio of 7:3 includes seven consonants and three vowels. Accordingly, seven consonants would be selected from a first letter group that includes the consonants of the alphabet and three vowels would be selected from a second letter group that includes the vowels of the alphabet. In the English language, the second group can include “A,” “E,” “I,” “0,” “U,” “W” and “Y.” The first group can include the 19 remaining letters plus “W” and “Y.” Thus, “W” and “Y” can be included in both the first and second groups in the English language.

The selection of letters in accordance with the distribution for an individual letter string can include random letter selection and/or frequency analysis selection. An individual series of randomly selected letters can be provided by a random letter generator, e.g., a computational or physical device designed to generate a sequence of letters that lacks any pattern, i.e. appears random. Computational random generators and physical random generators are well known.

As described above, selection based on a frequency analysis includes analyzing a word collection to determine the frequency that each letter occurs. Accordingly, the most frequently occurring consonants and/or vowels are selected in accordance with the distribution for the letter string on the tumbler that corresponds to the letter position in the word collection. For example, a collection of three letter words could be analyzed and the seven consonants and the three vowels that occur most frequently as the beginning letter of the words in the collection can be selected for the letter string on the first tumbler. Similarly, the seven consonants and the three vowels that occur most frequently as the middle and last letters would be selected for the letter strings on the second and third tumblers, respectively. In other embodiments according to the present disclosure, the number of letters in the strings can be more or less than ten, a distribution other than seven consonants and the three vowels can be used, and/or individual letter strings can have different distributions.

Thus, according to embodiments of the present disclosure, the selection of letters for a letter string is affected by the distribution of a letter string. Although a random selection of letters may not include a single vowel, the distribution of the letter string determines that a certain number of vowels will be included in the letter string. Similarly, even though a frequency analysis does not identify any vowels as occurring frequently enough to be included in a letter string, the distribution of the letter string again determines that a certain number of vowels will be included in the letter string. Conversely, only the most frequently occurring consonants and/or the most frequently occurring vowels will be included in an individual letter string in accordance with the distribution of that individual letter string. According to another embodiment, a distribution can be predetermined based on a consonant and vowel ratio of a word collection. For example, the first letters of words in a word collection can be analyzed to determine the distribution ratio of consonants and vowels. This distribution ratio is used when selecting the letters for the first tumbler.

Embodiments according to the present disclosure can include an initial or beginning tumbler with a consonant-to-vowel ratio that is greater than a final tumbler consonant-to-vowel ratio. Individual intermediate tumblers can have consonant-to-vowel ratios that are not greater than the initial tumbler consonant-to-vowel ratio and not less than the final tumbler consonant-to-vowel ratio. According to other embodiments, the distributions for tumblers, and hence the tumbler consonant-to-vowel ratios, can vary according to other patterns.

According to embodiments of the present disclosure, duplicate characters on an individual tumbler 300a-300e are prevented. In some embodiments, duplicate characters can be prevented by excluding from the random letter generator those characters that have already been randomly selected for a character string on an individual tumbler 300a-300e. According to embodiments of the present disclosure, there is no prohibition against duplicate characters in character strings for different tumblers 300.

According to some embodiments of the present disclosure, one or more letters can be preselected for one or more character strings. The remaining characters in the individual strings can then be selected randomly or by frequency analysis. In other embodiments according to the present disclosure, the character strings can include different portions of preselected and randomly selected characters for the individual tumblers 300a-300e.

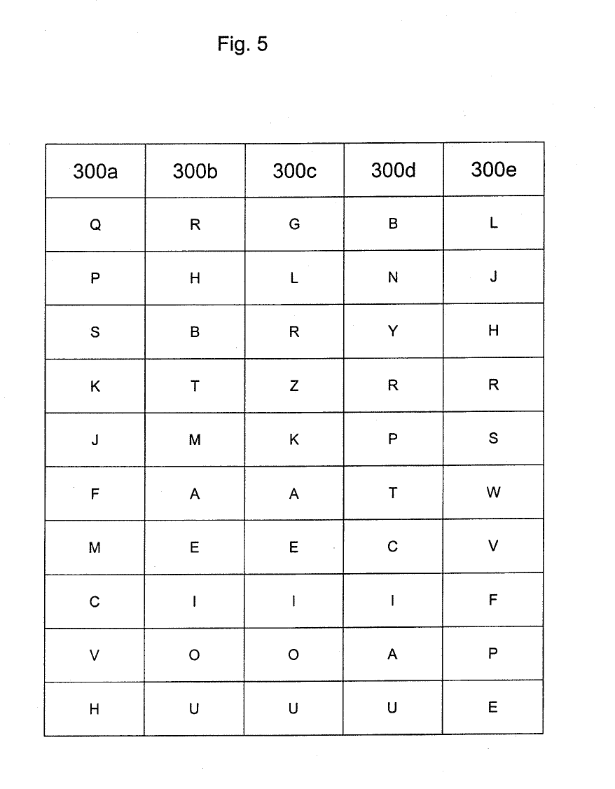

FIG. 5 illustrates one example of a device 10a according to an embodiment of the present invention. The device 10a includes five tumblers 300a-300e that include individual strings of ten letters. The individual letter strings shown in FIG. 5 include different four distributions, e.g., the second and third tumblers 300b and 300c can have the same distribution. Specifically, the distribution for the first tumbler 300a is characterized by a consonant-to-vowel ratio of 10:0, i.e., the string of letters for the first tumbler is entirely consonants. The selection of non-duplicate consonants can be randomly selected and include, for example, “Q,” “P,” “S,” “K,” “J,” “F,” “M,” “C,” “V” and “H.” The distribution for the second tumbler 300b is characterized by a consonant-to-vowel ratio of 5:5, i.e., half the string of letters for the second tumbler are consonants and half are vowels. The selection of non-duplicate consonants can be randomly selected and include, for example, “R,” “H,” “B,” “T” and “M,” and the five vowels can be preselected and include “A,” “E,” “I,” “O” and “U.” Preselection of this set of vowels can be standardized when the distribution specifies five vowels. The distribution for the third tumbler 300c is also characterized by a consonant-to-vowel ratio of 5:5. The selection of non-duplicate consonants can be randomly selected and include, for example, “G,” “L,” “R,” “Z” and “K,” and the five vowels can again be preselected and include “A,” “E,” “I,” “O” and “U.” The distribution for the fourth tumbler 300d is characterized by a consonant-to-vowel ratio of 7:3. The selection of non-duplicate consonants can be randomly selected and include, for example, “B,” “N,” “Y,” “R,” “P,” “T” and “C,” and the three vowels can be randomly selected and include, for example, “I,” “A” and “U.” The distribution for the fifth tumbler 300e is characterized by a consonant-to-vowel ratio of 9:1. The selection of non-duplicate consonants can be randomly selected and include, for example, “L,” “J,” “H,” “R,” “S,” “W,” “V,” “F” and “P,” and the one vowel can again be preselected, e.g., “E.” For the embodiment shown in FIG. 5, examples of possible unlocking combination words that a user can select include, for example, “JULIE,” “QUITE,” “CARPE,” “VALUE,” “SHARP” and “PRICE.”

In the event that a possible unlocking words is vulgar, explicit, inappropriate or otherwise objectionable, one or more of the letter strings can be adjusted. Specifically, a letter in one of the strings that is used to spell the objectionable word can be replaced with a substitute consonant or vowels in accordance with maintaining the distribution of that letter string.

The number of possible unlocking combinations from which to choose can depend on the length of the individual character strings and the letters selected for the individual character strings. Still other examples in accordance with the present invention can include devices with different numbers of tumblers, different lengths of character strings, and different distributions of the individual letter strings.

In accordance with embodiments of the present disclosure, a method for marking tumbler-style combination locks including a plurality of coaxial tumblers can include determining a first distribution of consonants and vowels in a first letter string for a first tumbler. The consonants and vowels in the first letter string are selected according to the first distribution for the first tumbler. A second distribution of consonants and vowels is determined for a second letter string for a second tumbler. The consonants and vowels in the second letter string are selected according to the second distribution for the second tumbler.

According to other embodiments of the present disclosure, a method for marking tumbler-style combination locks can additionally include selecting the consonants/vowels in accordance with an individual distribution. Selecting can be accomplished by randomly selecting the consonants/vowels from a group of consonants/vowels and/or selecting the most frequently occurring consonants/vowels corresponding to the tumbler position in a collection of possible unlocked configuration words.

According to some embodiments of the present disclosure, a method for marking tumbler-style combination locks can additionally include repeating the determination of a distribution for the individual tumblers, and repeating the letter selection in accordance with the distribution for the individual tumblers. According to some other embodiments of the present disclosure, a method for marking tumbler-style combination locks can additionally include excluding duplicate letters from individual letter strings.

According to further embodiments of the present disclosure, a method for marking tumbler-style combination locks can additionally include excluding objectionable words from a list of possible unlocking combinations. The excluded words can include words that are deemed to be vulgar, explicit, inappropriate or otherwise objectionable.

According, to other embodiments of the present disclosure, a method for marking tumbler-style combination locks can additionally include preselecting at least one or all of the letters for one or more of the tumblers, such as the first tumbler. For example, the letters for the first tumbler can be selected by choosing known or specifically determined commonly used first letters of words. The remaining letters for the other positions on the tumblers can be selected using a distribution of consonants and vowels based upon a determined ratio of consonants to vowels for corresponding letter positions for words having the same number of letters as the tumblers on the lock. In another embodiment, selecting letters for positions on the plurality of other tumblers can be accomplished by randomly or partially randomly selecting the consonants/vowels and/or selecting the most frequently occurring letters (or other characters) corresponding to the tumbler position in a collection of possible unlocked configuration words.

According to further embodiments of the present disclosure, a method for marking tumbler-style combination locks can additionally include selecting the letters for the tumblers by analyzing one or more lists of possible words to be spelled by the tumblers, analyzing the frequency of the letters and the positions of those letters in the words as a function of the frequency of the other letters in the other positions in the words. A different subset of words in the list of words may be responsible for the highest frequency letters determined for one position than another position, and the overlap may be minimal. For example, for a given word list of five letter words it may be determined that in position 1 (i.e., the first letter of the word) the highest frequency letters are ABCDEFGHIJ and in position 5 (i.e., the fifth letter of the word) the highest frequency letters are QRSTUVWXYZ. It may be the case that in the word list, there are few words that begin with ABCDEFGHIJ and end in QRSTUVWXYZ, resulting in a low word count for the lock. Therefore, the algorithm may additionally include determining high frequency letters only from a subset of the word list that can be spelled, based on the high frequency letters already determined in another tumbler position. For example, when the algorithm analyzes the letters in a word list at position 1 and determines that ABCDEFGHIJ are the highest frequency letters for that position, the algorithm reduces the word list to a subset of words that begin with ABCDEFGHIJ. The frequency counts are done again using this subset for the next position. For example, if OPQRSTUVWX are determined to be the highest frequency for position 2, the word list is further reduced to a second subset of words that includes words with OPQRSTUVWX in position 2, and so on.

The selection of the letters for each wheel can further include repetition and/or iteration of the frequency analysis. In the example above, it may be that the reduction of words in the wordlist as a result of selecting ABCDEFGHIJ for position 1 removes a subset of words from the word list that contain letters in position 1 that would have resulted in a higher final word count. That is, beginning the operation with position 1, then 2, then 3, 4, 5 and reducing the word list used to compute frequencies each time may result in a different word count than beginning with 5, then 4, 3, 2, 1, or beginning with 3, then 5, 2, 4, 1. Therefore, the algorithm may test every permutation, generating a set of high frequency letters for each position for each permutation. The algorithm further includes determining which permutation of the letters on the tumblers produces the highest final word count. This algorithm of selecting the letters for each tumbler of the lock can further include selecting a list of words to be excluded from the words that can be spelled by the tumblers, and selecting the letters on the tumblers to insure that the excluded words can not be spelled by the selected letters on the tumblers.

According to further embodiments, a method for making tumbler-style combination locks can additionally include selecting characters, such as letters, for at least one tumbler by determining the distribution of consonants (non-vowels) and vowels of a corresponding letter position in words of a word collection. For example, selecting letters for a first tumbler includes determining the distribution ratio of consonants and vowels of the first letters of words in a word collection and this distribution ratio is then used when selecting letters for the first tumbler. Selecting letters can include randomly or partially randomly selecting the letters for tumbler while maintaining the predetermined consonants/vowels distribution ratio. In another embodiment, the selection of letters for the tumbler can include selecting letters based upon the most frequently occurring consonants/vowels corresponding to the letter position in a word collection. The method can also include limiting the possible letters for use on other tumblers, such as the second tumbler, to the letters in the corresponding letter position in a subset of words from the word collection that begin with the letters selected for the first tumbler. The distribution ratio of consonants and vowels in, as an example, the second letter position of words in this subset of words is determined and used during the selection of letters for use on the second. This process can be used to select the letters for all positions on each of the tumblers. As disclosed above, an iterative process may be used that can include an algorithm to select and/or test every permutation, thereby generating a distribution for each letter position, for each permutation. and selecting the permutation with the highest word count. The selected set of letters (or characters) for all of the positions on the tumblers can then by applied or otherwise provided on the tumblers in the selected arrangement.

According to yet another embodiment, a method for making tumbler-style combination locks can include selecting letters on a plurality of tumblers using a distribution ratio of consonants and vowels and/or a frequency analysis, and then determining the number of words that the set of selected letters is capable of spelling. Some sets of the selected letters will be able to spell a relatively small number of words, and some of the randomly selected letters will be able to spell a relatively large number of words. In at least one embodiment, the selection step base upon the distribution ratio is configured so that once a character is selected for a tumbler, that character is restricted from being selected again for use on that tumbler. Accordingly, a character can not be repeated on a single tumbler. This selection process is such that the number of words that can be spelled by each set of selected characters can be then compared to a threshold value. In one embodiment, the numerical threshold value is 500 words, although other embodiments can have any other selected threshold value, e.g. 300, 750, 832, 1000, etc.

If the number of words from that can be spelled by the set of selected letters associated with each tumbler position is less than the threshold value, the steps repeat and another set of letters are selected for individual tumblers using a distribution and/or frequency analysis until the threshold value is met. When a set of selected characters is generated that can spell equal to or more words than the threshold value, a list of these words can be reviewed to determine if they are acceptable for actual use on a lock assembly. If the collection of words are not acceptable or for any other reason are not desirable for use on the lock assembly, then further sets of selected characters for the tumblers can be generated as discussed above. This process for selecting the letters for some or all of the positions on the tumblers of the lock assembly with textual combinations can greatly reduce the design and manufacture time, thereby reducing cost of the lock assembly. According to another embodiment, the method can further include preselecting at least one or all of the letters for at least one or more of the tumblers, such as the first tumbler. For example, the letters can be selected by choosing generally known or specifically selected commonly used first letters of words. The remaining letters for the other positions on the tumblers can be generating using a selected distribution ratio of consonants and vowels and/or a frequency analysis for each tumbler. In one embodiment, the generation of the remaining letters can follow the distribution and/or frequency analysis and comparison process as discussed above. If the number of words does not meet the threshold value, the step repeats itself by re-selecting characters for the open positions on the tumblers but not changing the preselected character(s). The step can repeat itself until at least the threshold value is met and/or an acceptable list of words that can be spelled is obtained.

From the foregoing, it will be appreciated that specific embodiments of the invention have been described herein for purposes of illustration, but that various modifications can be made without deviating from the spirit and scope of the invention. Accordingly, the invention is not limited by the specific embodiments.

What is claimed is:

1. A method for marking a tumbler-style combination lock including a plurality of coaxial tumblers, the method comprising:
determining a first distribution of consonants and vowels for a first one of the plurality of tumblers;
selecting the consonants and vowels according to the first distribution for the first tumbler;
determining a second distribution of consonants and vowels for a second one of the plurality of tumblers; and
selecting the consonants and vowels according to the second distribution for the second tumbler.

2. The method of claim 1 wherein selecting the consonants in accordance with an individual distribution includes at least one of (1) randomly selecting the consonants from a first group of letters and (2) selecting the most frequently occurring consonants corresponding to the tumbler position in a collection of possible unlocked configuration words, and wherein selecting the vowels in accordance with an individual distribution includes at least one of (1) randomly selecting the vowels from a second group of letters and (2) selecting the most frequently occurring vowels corresponding to the tumbler position in a collection of possible unlocked configuration words.

3. The method of claim 2 wherein the first group of letters includes at least the consonants of the alphabet and the second group of letters includes at least the vowels of the alphabet.

4. The method of claim 1 wherein determining the first distribution further includes determining a first word collection distribution from the ratio of consonants and vowels of the first letters in words in a word collection and selecting letters for the first tumbler using the first distribution

5. The method of claim 4 further including determining distributions for each tumbler in a tumbler position by determining a corresponding distribution from the ratio of consonants and vowels of a letter position in words in the word collection corresponding to the tumbler positions and selecting letters for each tumbler using the corresponding distribution.

6. The method of claim 4 further including creating a subset of words in the word collection of the words that have a first letter that was selected for the first tumbler.

7. The method of claim 1, further comprising:
determining a third distribution of consonants and vowels for a third one of the plurality of tumblers;
selecting the consonants in accordance with the third distribution includes at least one of (1) randomly selecting the consonants from the consonants of the alphabet and (2) selecting the most frequently occurring consonants corresponding to the third tumbler position in a collection of possible unlocked configuration words; and
selecting the vowels in accordance with the third distribution includes at least one of (1) randomly selecting the vowels from the vowels of the alphabet and (2) selecting the most frequently occurring vowels corresponding to the third tumbler position in the collection of possible unlocked configuration words.

8. The method of claim 1 wherein selecting the consonants and vowels for the individual tumblers includes excluding duplicate letters.

9. The method of claim 1 wherein selecting the consonants and vowels includes excluding objectionable possible unlocking words.

10. A method of making a tumbler style combination lock including a plurality of tumblers, each tumbler having a plurality of positions for letters, comprising:
selecting letters for each position on each of the tumblers wherein the letters are selected using a preselected distribution of consonants and vowels.
determining a first number of words capable of being spelled from the first set of using any arrangement of the lettered using one letter from each tumbler at a time; and
comparing the first number of words to a threshold to determine whether the threshold is met or exceeded.

11. The method of claim 10, further comprising:
repeating selecting the letters for each position on each of the tumblers to define a second set of letters;
determining a second number of words capable of being spelled from the second set of letters using any arrangement of letters using one letter from each tumbler at a time;
comparing the second number of words to the threshold to determine whether the threshold is met; and
applying one of the sets of letters to the plurality of positions on the tumblers.

12. The method of claim 10 wherein the threshold comprises a minimum number of words that can be spelled by the selected letters and comparing the first number of words to the threshold includes determining whether the first number of words meets or exceeds the minimum number of words.

13. The method of claim 10 further comprising preselecting at least one letter for application to one of the tumblers and selecting the rest of the letters for the first and second sets of letters.
vowels according to the second distribution for the second tumbler.

14. A method for marking a combination lock including a manipulatable member and a lock body, the method comprising:
determining a first distribution of consonants and vowels for at least one of the manipulatable member and the lock body; and
selecting the consonants and vowels according to the first distribution and applying the selected consonants and vowels to at least one of the manipulatable member and the lock body.

15. The method of claim 14, further comprising:
selecting at least one character form a first group of characters including alphabetic characters, numeric characters, symbols, colors, shapes and blanks and applying the at least one selected character to at least one of the manipulatable member and the lock body.

16. The method of claim 14 wherein selecting the consonants in accordance with a first distribution includes at least one of (1) randomly selecting the consonants from a first group of letters and (2) selecting the most frequently occurring consonants in a collection of possible unlocked configuration words, and wherein selecting the vowels in accordance with the first distribution includes at least one of (1) randomly selecting the vowels from a second group of letters and (2) selecting the most frequently occurring vowels in a collection of possible unlocked configuration words.

17. The method of claim 14 wherein the manipulatable member is a set of tumblers.

18. A combination lock, comprising:
a locking member movable between locked and unlocked configurations with respect to a lock body;
a plurality of tumblers individually rotatable with respect to the body, each tumbler having a plurality of characters thereon to define a letter string for the tumbler, and wherein the tumblers are configured adjacent to each other and positionable to align a letter from each letter string so as provide an unlocking combination that spells a word; each letter string having an individual distribution ratio of consonants-to-vowels, the letters for the letter strings being selected by:
determining a first distribution ratio of consonants and vowels for a first one of the plurality of tumblers, and then selecting the consonants and vowels according to the first distribution ratio for the first tumbler;
determining a second distribution ratio of consonants and vowels for a second one of the plurality of tumblers, then selecting the consonants and vowels according to the second distribution ratio for the second tumbler;
selecting letters for the remaining tumblers and applying the selected letters to the tumblers.

19. The combination lock of claim 18 wherein first tumbler letter string includes only consonants and a final tumbler letter string includes no more than three vowels.

20. The combination lock of claim 18 wherein the plurality of tumblers include first, second and third tumblers positioned with letters corresponding to first second and third letters in a word, and at least one of the second and third tumblers includes the vowels “A,” “E,” “I,” “O” and “U.”

21. The combination lock of claim 18 wherein the consonants in accordance with an individual distribution are randomly selected.

22. The combination of claim 18 wherein the vowels in accordance with an individual distribution include the most frequently occurring vowels corresponding to an individual tumbler position in a collection of possible unlocked configuration words.

23. The combination of claim 18 wherein the vowels in accordance with an individual distribution are randomly selected.

24. The combination lock of claim 18 wherein objectionable possible unlocked configuration words are excluded.

25. The combination lock of claim 18 wherein at least one tumbler includes a blank character.

26. A combination lock, comprising:
a locking member movable between locked and unlocked configurations with respect to a lock body;
a manipulatable member capable of being manipulated by a user, movable with respect to the lock body, wherein at least one of the manipulatable member and the lock body has characters thereon having a first distribution ratio of consonants-to-vowels, the characters being selected by determining a distribution ratio of consonants and vowels for at least one of the manipulatable member and the lock body, and then selecting the consonants and vowels according to the first distribution ratio.

27. The combination lock of claim 26 wherein a first portion of the characters on at least one of the manipulatable member and the lock body is selected in a non-random manner and the rest of the characters on at least one of the manipulatable member and the lock body are selected using the first distribution ratio of consonants and vowels.

28. The combination lock of claim 26 wherein the manipulatable member is a set of tumblers.
